(19) United States
(12) Patent Application Publication
(10) Pub. No.: US 2007/0038683 A1
(43) Pub. Date: Feb. 15, 2007

(54) Business intelligence system and methods

(75) Inventors: James Dixon, Winter Park, FL (US); Doug Moran, Merritt Island, FL (US); Marc Batchelor, Winter Springs, FL (US)

Correspondence Address: GOODWIN PROCTER LLP;PATENT ADMINISTRATOR, EXCHANGE PLACE, BOSTON, MA, 02109-2881, US

(73) Assignee: Pentaho Corporation, Orlando, FL (US)

(21) Appl. No.: 11/498,943

(22) Filed: Aug. 3, 2006

Related U.S. Application Data
(60) Provisional application No. 60/705,576, filed on Aug. 4, 2005.

(51) Int. Cl. G06F 17/30

(52) U.S. Cl. 707/202

(57) ABSTRACT

In general, the invention relates to a business intelligence platform. In one aspect, data is logged such that information about execution instances can be obtained. In another aspect, action sequences are developed, stored, and executed, such that use of a variety of components can be specified.

### RELATED APPLICATIONS

This application claims the benefit of U.S. Provisional Patent Application Ser. No. 60/705,576, entitled, “BUSINESS INTELLIGENCE SYSTEM AND METHODS,” filed on Aug. 4, 2006, incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### APPENDIX ON COMPACT DISC

This application includes an Appendix of computer code on compact disc, hereby incorporated by reference, in the file named “appendix-1-source.txt.txt,” created on Aug. 3, 2006, and of size 314,516 bytes, and the file named “appendix-1-source-2.txt,” created on Aug. 3, 2006, and of size 39,900 bytes.

### BACKGROUND

Business Intelligence is a sector of the information technology (IT) market that includes applications and tools for gathering, reporting, and analyzing business data. Traditional Business Intelligence (BI) tools are costly, complex and fall significantly short of enabling enterprises to achieve the sought-after benefits in efficiency and effectiveness. Software vendors promise that BI will provide the aggregation, analysis, and reporting capabilities necessary to transform data into the high-value insight that allows management to make more timely and informed decisions. Unfortunately this typically amounts to little more than reporting and reporting alone is not enough.

For example, in BI systems, it is difficult to track the performance and execution of automated tasks in distributed and long-running processes. Information describing errors, warnings, informational messages and diagnostics is usually written to text files (log files) sequentially without any context about the task being executed at the time. For example if an error is detected attempting to send an email or format a report, the error message does not include the email recipient or the name of the report.

To compound this problem, messages about many tasks executing in parallel typically are written to the same location, making it impossible to determine if adjacent messages are related to each other. Some processes take a long time to complete and include dormant periods. It may be impossible to determine which messages relate to any other given messages. For example, the process of fully assimilating a newly hired employee into an organization can take weeks and involve many diverse tasks. Each of these tasks differs in the component that is executing each task, the date and time of execution of each task, and the person or system completing each task, but they are all inherently connected to the process they are a part of.

In addition, with current solutions, it can be difficult to manage a business process with software applications that have been designed solve a specific business need. Individual applications are not “aware” of the process in which they take part which makes it difficult to integrate them. Existing solutions to this problem fall into three categories: Monolithic applications, Workflow Engines and Custom programming.

Monolithic Applications are large programs or suites of programs that try to solve every part of every business problem. Unfortunately, it is difficult to predict what problems will need to be solved as the business environment changes every day e.g. Sarbanes-Oxley or the invention of e-commerce, and so these systems may need frequent updates. Also, this approach does not allow a company to select the best solutions available as they are locked into one application or vendor.

Workflow management systems allow the business process to be defined and managed. Application interfaces are available but require application programming to implement, and they may need to be updated as application interfaces change.

Custom programming can be used to solve larger problems using standalone applications. Custom programming of solutions is expensive and difficult to maintain. It is also difficult and time consuming to modify as the business requirements change.

### SUMMARY OF THE INVENTION

In a business intelligence application workflow, processes often create many sub-processes and the messages and events of the sub-process cannot be related to the messages and events of the parent process unless the relationship between the processes is known and maintained.

In one aspect, some embodiments of the present invention facilitate improved development and debugging of business systems, through the use of improved logging of message and events, in which the context of such messages and events within the system operation can be identified. For example, this allows a system administrator to identify the system and/or subsystem in which an event is associated, and take appropriate action.

In general, in one aspect, the invention relates to a system for logging data, including an audit data store for storing information about instances of processes; and a log file that includes for each log file entry an identifier of the executing instance that generated the entry. The audit date store includes information about the process instances as they relate to the operations of the system. The information in the log file entry can be used to collect information from the audit data store, such that the operational tasks that resulted in the logged events can be identified.

In general, in another aspect, a method for logging data in a business process workflow includes assigning a session identifier to a user session upon initiation by a user of the user session, and generating first audit data comprising the session identifier and a user identifier. The method includes assigning an instance identifier to an execution instance initiated by the user during the user session, and generating second audit data comprising the session identifier and the instance identifier. The method also includes generating log entries during the execution of the execution instance, the log entries including the instance identifier. The audit data may be included in an audit data database table, in a file, in a log file, or any other suitable data store.

A user or a software program can use the audit data to associate log file entries with execution instances, sessions, and users. For example, log entries may be associated with a session based on the second audit data. The session may be associated with a user based on the first audit data.

In some embodiments, the execution instance includes tasks to be performed on behalf of the user. For example, the execution instance may include a reporting task, a notification task, a query, and so on. The tasks may generate log entries using a log function. The log function may be provided by an application, logging tool, and so on. Log entries may be generated upon an error, and/or also upon the start, operation, or completion of an execution instance, or the components called by an execution instance.

In one embodiment, the initiation of a user session includes authentication of the user.

In general, in one aspect, a system for logging data in a business process workflow, includes an audit data store for storing identifiers of execution instances, session identifiers, and user identifiers; and a log file that includes for each log file entry generated by an execution instance an identifier of the execution instance that generated the entry.

In general, in another aspect, a method for executing applications that form a business process includes defining an action sequence that includes a description of business intelligence processes to call and the order in which they should be called, storing the action sequence in a solution repository, and executing the action sequence such that the business intelligence processes defined in the stored action sequence are called in the order specified, thereby implementing a business process.

In one embodiment, the action sequence includes a description of components to call and the order in which they should be called. The action sequence may be implemented in self-describing language, such as XML. The execution may be performed by a runtime engine. The method may also include any or all of developing the action sequence, testing the action sequence, and validating the action sequence.

The solution repository may be a database or other suitable for storing action sequences. The solution repository may include version control and other auditing and safeguards.

In various embodiments, the business intelligence processes may be business intelligence platform components.

In some embodiments, the output of one component in the action sequence is provided as input to a next component in the action sequence.

In general, in another aspect, a business intelligence platform for executing applications that form a business process, includes a development environment for defining an action sequence comprising a description of business intelligence processes to call and the order in which they should be called, a solution engine for storing the action sequence in a solution repository, and a runtime engine for executing the action sequence such that the business intelligence processes defined in the stored action sequence are called in the order specified, thereby implementing a business process.

In general, in another aspect, the invention relates to a method for executing applications that form a business process. The method includes defining an action sequence that includes a description of processes to call and the order in which they should be called. The method includes storing the action sequence in the solution repository, and performing the tasks defined in the stored action sequence, thereby implementing a business process.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a block diagram of an embodiment of the invention.

FIG. 2 is a block diagram of an embodiment of the invention.

FIG. 3 is a block diagram of an embodiment of the invention.

FIG. 4 is a block diagram of an embodiment of the invention.

FIG. 5 is a flowchart depicting an embodiment of the invention.

### DETAILED DESCRIPTION

In one embodiment, a BI platform is process-centric, and uses a workflow engine as a central controller. The workflow engine uses process definitions to define business intelligence processes that execute on the platform. The processes may be customized and new processes can be added. The processes are defined in a standard process definition language that is externally viewable, editable, and customizable such that there is no hidden business logic. The platform may include components and reports for analyzing the performance of the processes. Logging, auditing and security are built in at the core and are utilized automatically to ensure that there is always an accurate audit trail available for both governance and performance monitoring.

Such a BI platform may be considered solution-oriented because the operations of the platform are specified in process definitions and action documents that specify every activity. These processes and operations collectively may define a solution to a business intelligence problem that may be easily integrated into business processes that are external to the platform. The definition of a solution may contain any number of processes and operations.

In one embodiment, the platform includes a BI server, a BI workbench, and desktop inboxes. The BI server includes a BI framework and BI components. The server also includes a runtime engine, which is driven by the workflow engine, and which coordinates the execution and communication between BI components. In one implementation of a server includes one, two, or more of the following features: common metadata in the form of solution definition documents; common user interfaces and user interface components; security; email and desktop notifications; installation, integration and validation of all components; sample solutions; application connectors; usage and diagnostic tools; design tools; customization and configuration; and process performance analysis reports and ‘what-if’ modeling.

The BI Workbench is a set of design and administration tools that may be integrated into an Integrated Development Environment, such as the popular Eclipse environment, available from the Eclipse Foundation. These tools allow business analysts or developers to create reports, dashboards, analysis models, business rules, and BI processes. BI solutions may be designed using the BI workbench and deployed to the server.

The inboxes may deliver tasks and report and/or exception notifications. In various embodiments, the desktop inboxes may be, for example, an RSS reader, email client software, an instant messenger client, or a special-purpose inbox alerter.

In one embodiment, the system is implemented as a combination of original source code and open source components that have been integrated to form a scalable, sophisticated BI platform that may include such features as a J2EE server, security, portal, workflow, rules engines, charting, collaboration, content management, data integration, analysis, and modeling features of the system. Many of these components may be standards-based.

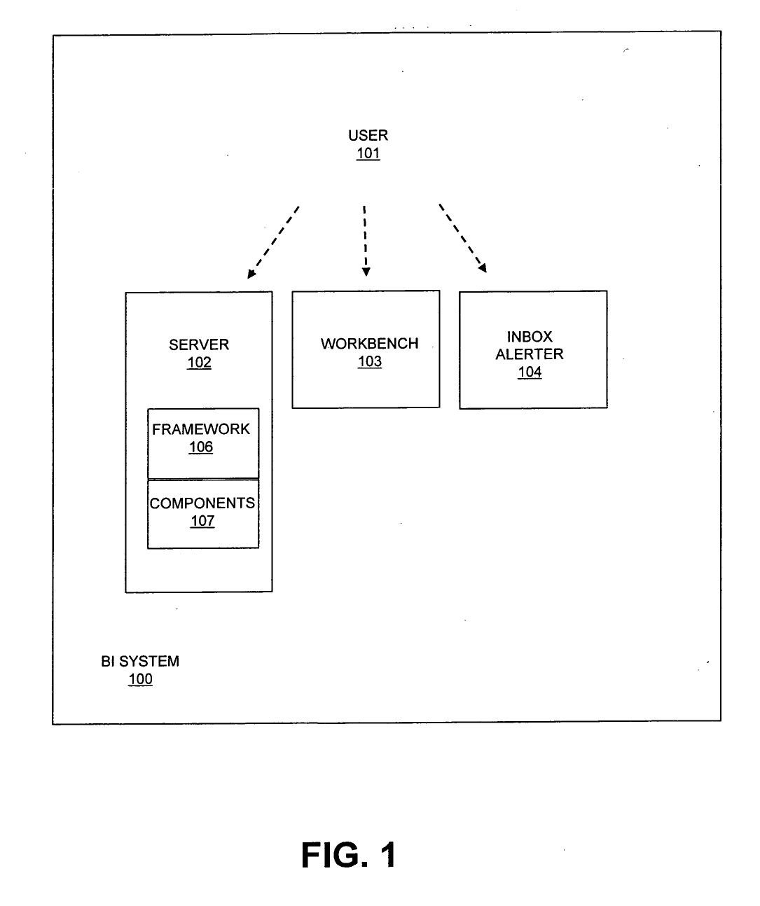

Referring to FIG. 1, in one embodiment, an embodiment of a BI Platform 100 includes a server 102, a workbench 103, and an inbox alerter 104. The user can configure the server 102 using the workbench 103. The server 102 includes functionality for running the BI platform, as configured by the user 101 using the workbench 103. The inbox alerter 104 is used to notify the user 101 when there is a message for the user 101 from the server 102.

In one embodiment, the server 102 may include a framework 106 and components 107. The server may run inside a J2EE compliant web server such as Apache, JBOSS AS, WebSphere, WebLogic and Oracle AS. The framework 106 and components 107 may run or be embedded within such a web server other servers or applications. Components 107 are modules that may be added to or removed from the system for specific functionality and configuration.

The platform 100 may be integrated with external systems that provide data to drive the reporting engine and that receive events from the workflow engine.

The inbox alerter 104, optional in some embodiments, is software that may be installed on machines of the users that wish to take advantage of its functionality. In various embodiments, the inbox alerter 104 may provide many ease-of-use features such as notification of new workflow tasks, notification of report delivery, and management of off-line content. In some embodiments, the inbox alerter 104 uses an RSS standard feed provided by the server 102, and may be implemented using any RSS reader that supports authenticated feeds. The inbox alerter can be used to receive notifications from the server. The inbox alerter may be implemented with an email or instant message program, toolbar, or other message alert.

In various embodiments, the Pentaho BI Platform integrates workflow, business rules, information delivery and notification, scheduling, auditing, application integration, content navigation, user interfaces, design and administration tools with reporting, analysis, dashboards, and data mining components and engines.

In general, The architecture of the Pentaho BI Platform has many advantages. For example, by building, integrating, and enhancing use of open source components into a single integrated platform, the cost of BI implementations is drastically reduced. Lower cost of ownership means resources can be invested elsewhere, such as increasing the scope of the Business Intelligence project and deploying more advanced content and capabilities to end users. In other words, a significantly higher percentage of the project budget can be spent on requirements gathering, implementation, and services increasing the successfulness of the project. Delivering the software with no cost for prototyping enables prototyping to be performed for any duration required. Delivering the software with no cost for prototyping enables project requirements iterations to be performed for any duration required.

A workflow-based platform provides a true service-oriented architecture that makes it easier to integrate Business Intelligence into any business process. A workflow-based platform the system also makes it easier to cluster and scale. Process performance reports allows business intelligence projects to be continually tuned and improved. Information delivery and notification into the platform reports, analysis, tasks, and decisions points can be routed anyone involved in a business process. Multiple rules engines allows business logic to be customizable. Incorporating reporting, analysis, and dashboards into the platform provides for an increase in sophistication of the business intelligence solution that be performed at a pace that is right for the organization.

Data mining features allows advanced data analysis to be added in a timely basis. Integrating auditing and audit reports, system monitoring, and administration features into the platform the system makes it easy to maintain. By providing intuitive user interfaces that are readily customizable, the system is easier to use and the cost of training users is reduced.

Implementation of the platform involved defining requirements for the architecture, determining whether to design and build each component or use existing third party ones (e.g., open source components), identifying suppliers for each of the many components/projects, research on each component/project, installing and configuring each component, designing and implementing an integration layer for each component, designing and implementing consistent user interface components, designing and implementing consistent administration tools, design and implementing analysis and modeling tools, designing and implementing the common services and infrastructure, designing and creating repositories, designing and implementing new components or enhance existing components with new functionality, integrating security, integrating auditing, design and implement process performance reports, and create a common definition language.

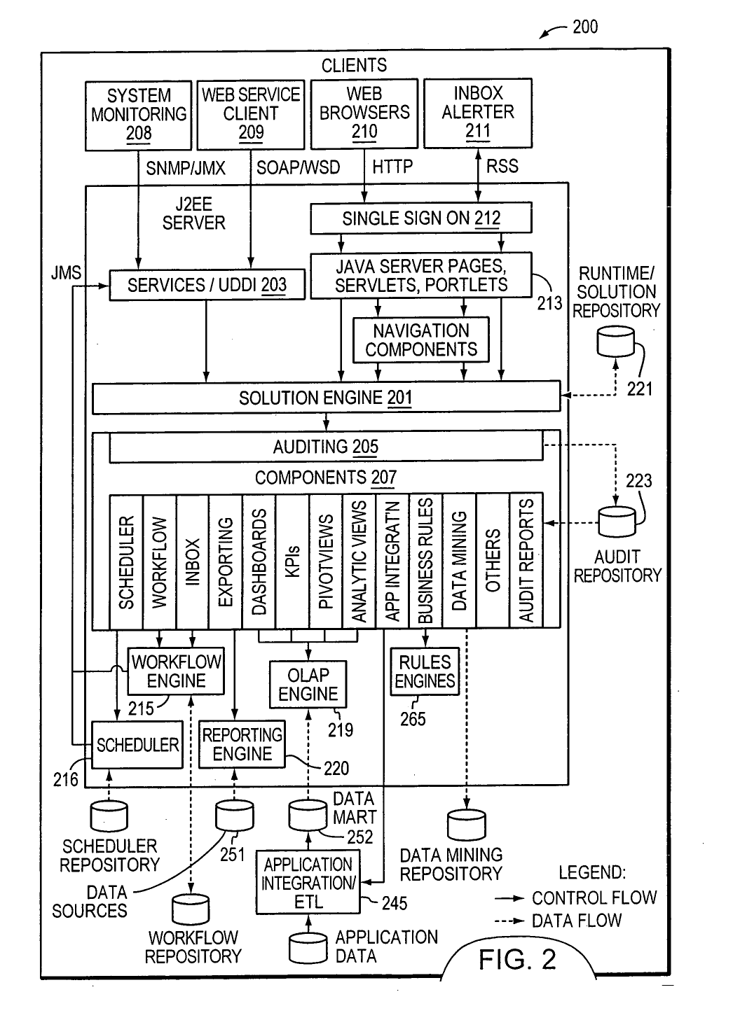

Referring to FIG. 2, relationships of major components within an exemplary server architecture 200 are shown. The solution engine 201 serves as a central controller and manages access to the components. The other components of the server may make use of the solution engine 201 for information about the available solution documents 221, for security, for information about reports and workflow items, for data, and for auditing.

For a particular solution, the behavior, interoperation, and user interaction of each sub-system may be defined by a collection of solution definition documents. These documents are managed by the solution engine 201, and implemented, for example, by the workflow engine 215. In various embodiments, the solution definition documents are XML documents that contain definitions of business processes (e.g., XPDL) and definitions of activities that execute as part of processes, on demand, or called by web services. These activities include definitions for data sources, queries, report templates, delivery and notification rules, business rules, dashboards, and analytic views. They also may specify the relationships between these items. The solution definition documents can be copied from one server to another and may be freely distributed. More than one solution can execute in the server at the same time.

The services of the framework (e.g., Solution Engine 201, Services/UDDI 203, Auditing 205, Components 207) provide web services to external applications (e.g., System Monitoring 208, Web Service Client 209, Web Browsers 210, and Inbox Alerter 211), and have access to the same solution engine 201 as the user interface components (e.g., Single Sign On 212, Java Server Pages, Servlets, Portlets 213), and may be called by the workflow engine 215 and scheduler 216 to execute system actions.

The server 200 contains engines (e.g., OLAP engine 219, reporting engine 220) and components 207 for reporting, analysis, business rules, email and desktop notifications, and workflow. These components may be used together, as specified by the solution documents, so that they can be used to solve a specific business intelligence problem.

In various embodiments, the platform may include embedded repositories that store data used to define, execute and audit a solution. For example, the platform may include a solution repository 221 that includes metadata to define solutions, a runtime repository (shown in this embodiment as using the same repository as the solution repository 221) that includes items of work that the workflow engine is managing, and an audit repository 223 that includes tracking and auditing information. In various embodiments, the repositories may be stored inside an RDBMS that is external to the platform, such as FireBird (in a preferred embodiment) or MySQL. These repositories can may be implemented with other commercially available relational databases such as those available from Oracle, SQLServer or DB/2, for example. The solution repository and the workflow repository, for example, may be different tables in the same database.

The server 200 allows the various functions of the platform to be presented to users in a consistent, familiar look and behavior. For example, one component may generate a list of reports that a user has access to, a second may list the task-related deadlines in a calendar, and a third may show the current tasks that the user needs to complete. The content generated by each component may be relevant for each user's roles. In one embodiment, component content can be retrieved as XML, HTML, or displayed by portlets according to the JSR-168 specification. In this manner, the portlets may be embedded into any portal that supports the JSR 168 standard such as IBM WebSphere, OracleAS Portal, and BEA WebLogic Portal. XSL and CSS stylesheets used by the components to generate reports online and report content may accessible to a user and can be fully customized using the workbench.

In various embodiments, the server contains infrastructure for system administration. This may include system monitoring (SMNP) services, usage reports, Web Service support, configuration validation tools, and diagnostic tools.

The server also may include components and related engines to provide advanced process performance reporting and analysis. This may include “slice-and-dice,” “what-if,” and data-mining capabilities that can be performed on the attributes of workflow items, individual tasks, users, and services involved in workflow tasks. The server also may include a tool for Enterprise Application Integration (EAI)/Extraction, Transformation, and Load (ETL) 245.

In various embodiments, the BI platform may be built with open source components, and may be run in open source or proprietary application server. The platform may be integrated with external applications that provide data 251, 252 to drive the solutions. This data may be loaded into a data warehouse or data mart 252 using an ETL tool.

In various embodiment, auditing is built into the platform components. The platform may provide process performance reports by extracting historical and real-time data from the workflow and auditing repositories, for example, using the audit reports component to display the reports.

In some embodiments, the platform is designed such that engines and components may be added or removed. Each engine typically has corresponding component(s) that integrate the engine into the platform. Engines can be switched out for other engines or added to the platform if the necessary components are created.

In various embodiments, multiple rules engines may be included in the platform so that business logic is exposed and can be customized easily. Additional rules engines can be added to the system. The business rules engines are external to the components, and any component may utilize any rules engine 265.

Not all components are shown in FIG. 2. Other components (not shown) include email, printing, message formatting, workflow instance attribute management, and process performance reporting and ‘what-if’ analysis.

In various embodiments, the J2EE Server provided is JBoss AS, but any Java JDK 1.4 compliant application server can be used.

In various embodiments, the Platform provides user interfaces built with Java Server Pages (JSPs), servlets and portlets. Third party or customized JSPs, servlets or portlets also may be used.

In various embodiments, the platform includes an open source On-Line Analytical Processing (OLAP) engine that allows multidimensional data to be navigated, reported, and analyzed, referred to as Mondrian, but any MDX-compliant OLAP server could be used, for example, Microsoft OLAP Services and Hyperion Essbase.

In various embodiments, the platform provides a javascript-based and SQL-based rules engines and may include support for such rules engines as ILOG JRules, Drools and Jess.

In various embodiments, the platform may integrates and enhance existing popular third-party open source components, such as one or more of Mondrian OLAP Server and jPivot Analysis Front-End, Firebird RDBMS, Enhydra ETL, Shark and JaWE Workflow, JBoss Application server, Hibernate and Portal, Weka Data Mining, Eclipse Workbench and BIRT reporting components, JOSSO single sign-on and Lightweight Directory Access Protocol (LDAP) (A standard protocol for accessing properties about resources, e.g. employees or web services) integration, and the Mozilla Rhino Javascript Processor.

In various embodiments, the platform can utilizes such open standards and protocols as XML markup language; JSR-94—JCP's Rules Engine API; JSR-168—JCP's Portlet Spec; SVG —W3C's Scalable Vector Graphics; XPDL —WFMC's XML Process Definition Language; XForms W3C's Web Forms; MDX —Microsoft's OLAP Query Language; WSBPEL —Oasis's Web Services Business Process Execution Language (A standard system used to orchestrate workflows across multiple services); WSDL —W3C's Web Services Description Language; and SOAP —W3C's Simple Object Access Protocol.

In one exemplary embodiment, a preconfigured sample deployment is provided so that the platform can be tested quickly and easily. The deployment includes JBoss Application Server; JBoss Portal V2.0, a JSR-168 certified portal server; Example JSPs that demonstrate platform component usage; Sample data; Sample reports and BI processes; users and roles used in the examples.

Workbench

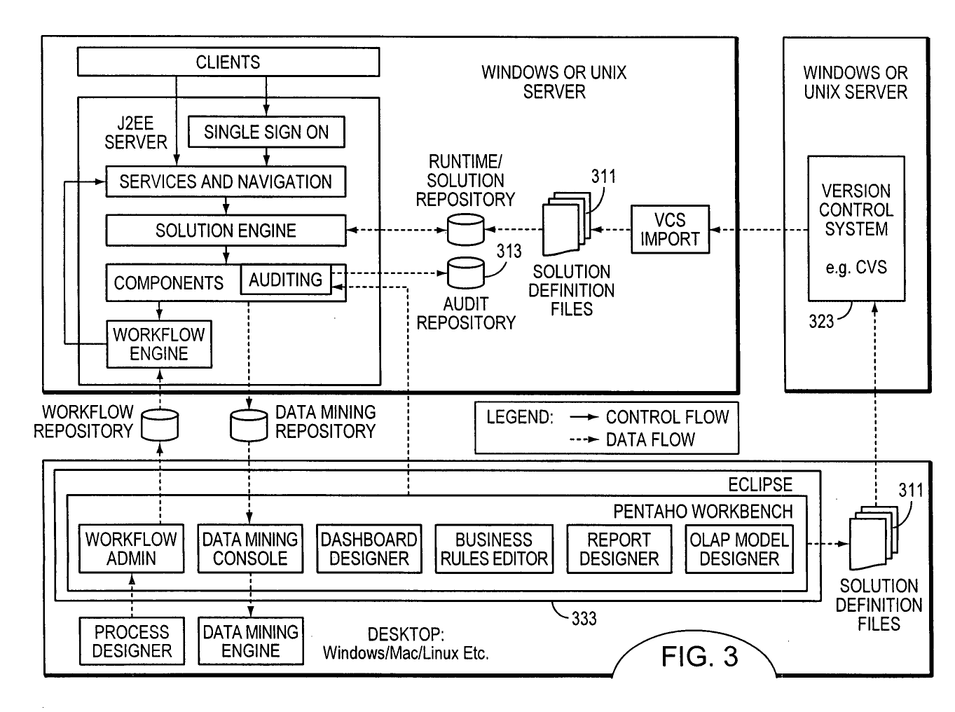

Referring to FIG. 3, an embodiment design and administration workbench provides easy to use design tools for reports, dashboards, analytic views; a workflow process designer; business rules editors; a data mining console for data preparation; and OLAP modeling tools. The workbench generates workflow definitions and Solution Definition files 311 that are used by the server to execute BI solutions. The workbench creates an audit trail for the creation and editing of solution definition documents that is stored in the audit repository 313. A version control system 323 can be used to maintain the Solution Definition documents and provide synchronization and versioning capabilities. The workbench allows solutions, reports, queries, business rules, dashboards, and workflows to be viewed and edited graphically. The BI Workbench may be a Java application that is installed on system administrator's and designer's desktop computers.

In some embodiments, the workbench is implemented using an integrated development environment (IDE) 333, which may be the Eclipse IDE available from the Eclipse foundation. Like the Eclipse IDE, the workbench is implemented in Java, and so runs on multiple platforms.

Embedded Architecture

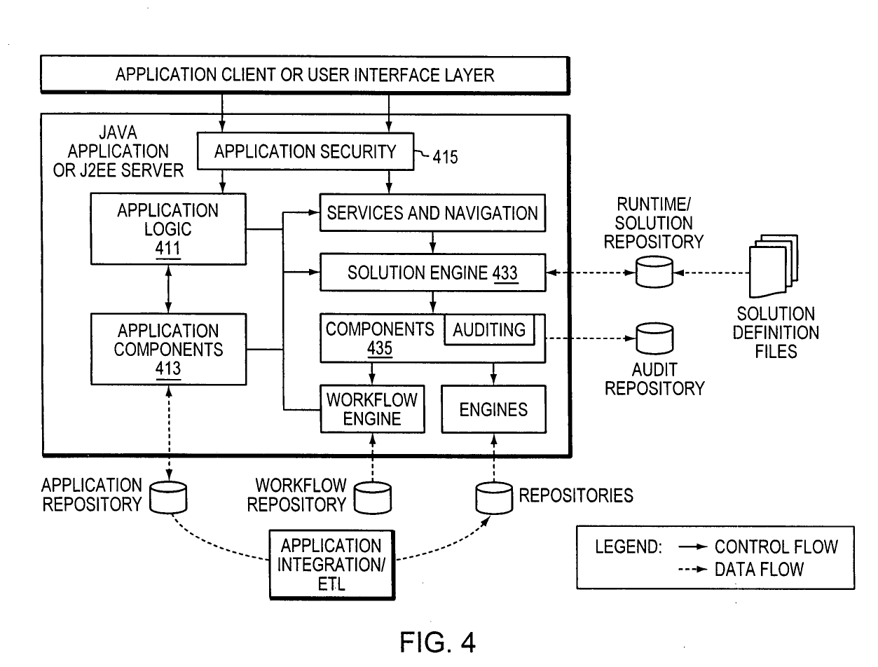

Referring to FIG. 4, an architecture diagram for an embedded architecture is shown. In one embodiment, because the platform is implemented in Java, portions or all of the technology may be embedded into standalone or server-based Java applications. An external application provides its own logic 411, components 413, and security 415, and yet can make use of the platform as shown in FIG. 2. The solution engine 433 and components package 435 may be installed. Only those components, engines, and repositories that are used need to be configured. For example, in various embodiments, one, two, or more of the following may be included: workflow engine, workflow repository and runtime repository; auditing and audit repository; Application Integration/ETL for data extract, transformation and loading; user interface components; solution repository and solution definition files.

Logging

In some embodiments, server components run inside of an application server, such as a J2EE application server. The components may use the logging facility provided by the application server to record messages to be stored in a log, such as when components start and stop, and the success or failure of certain operations. Such a log is useful for identifying problems, and also for purposes of auditing user activity. Other logging facilities also may be available through operating systems, frameworks, or add-on components. In general, these logging facilities do not have the capability of associating

In some embodiments, each user is assigned an session identifier when the user initiates a session, for example, when she authenticates to the server. The identifier is stored in a table (e.g., a database table) of user identifiers. The session identifier also (or instead) may be stored in a log file. When a user initiates an execution instance, which may be a task, such as a report or workflow, the instance is assigned another identifier. The instance identifier may be stored in a table, such that the instance identifier may be associated with the user who initiated it. The instance identifier also (or instead) may be written to a log file along with the session identifier, such that the execution instance identifier may be associated with a user.

In some such embodiments, the platform uses the identifier associated with the execution instance for all sub-tasks initiated by the instance. This identifier associated with the execution instance is included in log information for all messages. In this way, the platform may make use of the logging features that are provided by an application server, but at the same time, generate log files that may be associated with particular execution instances, sessions, and users, so as to allow for debugging and auditing, even when the execution instance implements a variety of different components.

Thus, in one embodiment, an audit data store (e.g., file, database, etc.) is used to accumulate information about execution instances. The audit data store may include an identifier for each process, identifier of each executing instance, identifier of the parent of the instance (either an instance of another process, or a person, or a scheduler etc), identifier of an activity, identifier of the component executing the activity, date and time of each event, and any relevant attributes. It should be understood that the data store can store additional information and/or some subset of the above. The data store is updated when an instance is executed. Tasks may add to the data store through use of a function that stores data in the data store. The data store can be archived at intervals but the data typically is not deleted or altered during system execution.

Message entries in log files are coded so as to include the identifier of the executing instance. By providing the identifier to the execution instance, the system can then provide much more detailed information about the messages. This may be accomplished by providing the identifier associated with an execution instance to a logging function.

In one embodiment, a computer program is used to analyze log file data by making use of the log file data (having the contextual messages) and the audit data store into data structures that describe the structure and links between every logged message and every audited event.

The computer code in the attached Appendix, incorporated by reference, provides an exemplary embodiment of a system of metadata and software components that demonstrates collation, presentation, and analysis of the data within such an audit data store.

The metadata includes definitions of queries that extract from the Audit Analysis Data Store, including: the relationship and intersections between processes based on sub-process creation, common activities, common components, and common participants; descriptions of events and messages for a complete process or sub-process; descriptions of events and messages for one or more selected activities or components; descriptions of events and messages related to the actions of one or more selected participants; details of the individual and cumulative duration of processes, activities, or components; descriptions of meaningful analysis and modeling that can be applied to the audit data store.

Below, in Table 1, as illustrative examples, is a depiction of process event data store records:

TABLE 1
Example Process Event Data Store Records

| | |
|---|---|
| (1). | 2005/08/03 12:41:36, FCBEA58AA2C0EBA084CEB7B6F642685B, org.pentaho.session.PentahoHttpSession, |
| | session_start, jdixon |
| (2). | 2005/08/03 12:45:23, org.pentaho.ui.ViewAction, FCBEA58AA2C0EBA084CEB7B6F642685B, report-1. xml, |
| | org.pentaho.solution.SolutionEngine, instance_start, fc7f2c88-043d-11da-82ec-3d1f62a10236 |
| (3). | 2005/08/03 12:45:23, org.pentaho.ui.ViewAction, fc7f2c88-043d-11da-82ec-3d1f62a10236, report-1.xml, |
| | org.pentaho.runtime.RuntimeContext, action_sequence_start |
| (4). | 2005/08/03 12:45:23, org.pentaho.ui.ViewAction, fc7f2c88-043d-11da-82ec-3d1f62a10236, report-1.xml, |
| | org.pentaho.jasper.JasperReportsComponent, component_execution_started |
| (5). | 2005/08/03 12:45:25, org.pentaho.ui.ViewAction, fc7f2c88-043d-11da-82ec-3d1f62a10236, report-1.xml, |
| | org.pentaho.jasper.JasperReportsComponent, component_execution_ended, failed, 0.8 |
| (6). | 2005/08/03 12:45:25, org.pentaho.ui.ViewAction, fc7f2c88-043d-11da-82ec-3d1f62a10236, report-1.xml, |
| | org.pentaho.runtime.RuntimeContext, action_sequence_end, 1.1 |

The first row shows an entry stored when a session is created. Sessions are created for anything that requests an action from the system including users, schedulers, web services. Each session has a unique identifier. This entry is generated by the BaseSession object which all the other session types inherit from. The entry is generated during BaseSession( ) in org.pentaho.session.BaseSessionjava and includes the date/time of the event, the identifier of the session, the specific session type, the event type and the name of the session (e.g. user name).

The second row shows an entry stored when an execution instance is created. An execution instance is created when a session needs to execute a new activity. If the execution instance is long running, the sessions involved will not create new execution instances but re-use the persistent one. New execution instances are created by the SolutionEngine object which is used by all the session objects to execute actions. The entry is generated during execute( ) in org.pentaho.solution.SolutionEnginejava and includes the date/time of the event, the identifier of the requesting object (a servlet, message queue listener, scheduler object, business process etc), the identifier of the session requesting the new execution instance, the identifier of the activity or task being performed, the identifier of the object creating the execution instance, the type of the event and the identifier of the newly created execution instance.

The third row shows an entry stored when an action sequence is started. Actions are executed by the RuntimeContext, which is created by the SolutionEngine. The entry is generated during validateSequence( ) in org.pentaho.runtime.RuntimeContextjava and includes date/time of the event, the identifier of the requesting object, the identifier of the execution instance, the identifier of the activity or task being performed, the identifier of the object starting the executing, and the type of the event.

The fourth row shows an entry stored before a component executes an action. Components can be added to the system using configuration only, the system does not have to be rebuilt when components are added. The entry is generated by the RuntimeContext object to ensure that all component actions are stored. The entry is generated during executeAction( ) in org.pentaho.runtime.RuntimeContextjava and includes date/time of the event, the identifier of the requesting object, the identifier of the execution instance, the identifier of the activity or task being performed, the identifier of the component executing the action, and the type of the event.

The fifth row shows an entry stored after a component executes an action. The entry is generated by the RuntimeContext object to ensure that all component actions are stored. The entry is generated during executeAction( ) in org.pentaho.runtime.RuntimeContextjava and includes date/time of the event, the identifier of the requesting object, the identifier of the execution instance, the identifier of the activity or task being performed, the identifier of the component executing the action, the type of the event, the result of the action, and the duration.

The sixth row shows an entry stored when an action sequence is completed. The entry is generated during executeSequence( ) in org.pentaho.runtime.RuntimeContextjava and includes date/time of the event, the identifier of the requesting object, the identifier of the execution instance, the identifier of the activity or task being performed, the identifier of the object ending the executing, the type of the event, and the duration

As shown below in TABLE 2, an exemplary log file entry has a number of components. This example show a log file entry that contains the auditing metadata.

TABLE 2
Example Log File Entry

2005-08-03 12:45:25, 777 ERROR [org.pentaho.solution.SolutionEngine]
fc7f2c88-043d-11da-82ec-3d1f62a10236:SOLUTION-ENGINE:
jasper-reports-test-1.action.xml Database connection failed

The elements of the entry in the example of TABLE 2 include:
2005-08-03 12:45:25,777- Date and time of the log file entry
ERROR - The kind of entry (ERROR, WARNING, INFO, DEBUG, or TRACE)
[org.pentaho.solution.SolutionEngine]- the class of the object creating the entry
fc7f2c88-043d-11da-82ec-3d1f62a10236 - the identifier of the executing instance
SOLUTION-ENGINE - the type of object creating the entry
jasper-reports-test-1.action.xml - the activity being performed
Database connection failed - the message

Note that the identifier of the executing instance matches entries in the Process Event Data Store. The Process Event Data Store entries can be used to provide information about the history and context of the log entry.

An exemplary embodiment of computer code is included in the Appendix on compact disc, incorporated by reference into the application.

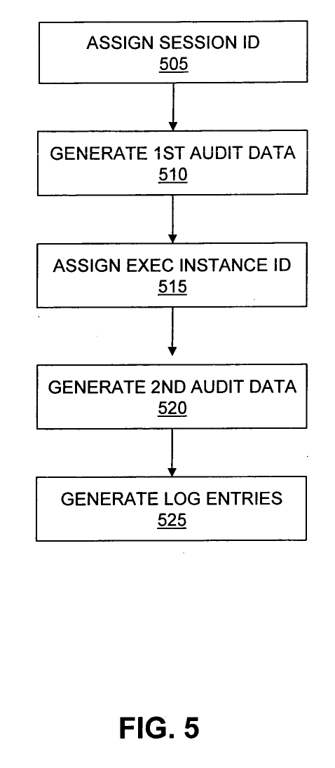

Referring to FIG. 5, in one embodiment, a method for logging data in a business process workflow includes assigning a session identifier to a user session upon initiation by a user of the user session (STEP 505). The session identifier may be assigned in any number of ways. In one embodiment it is assigned up authentication and initiation of a session. Thus, when a user connects to the server and logs in, the session identifier is assigned. First audit data is generated (STEP 510), which includes the session identifier and a user identifier. The audit data may also include other information. The audit data may be stored in a database, file, log file, and so on. When a user, during a session, takes an action that initiates an execution instance, an instance identifier is assigned to the execution instance initiated by the user during the user session (STEP 515). The action may be any sort of action, such as requesting a report, extracting data from a database, starting a process, and so on. Second audit data is generated that includes the session identifier and the instance identifier (STEP 520). In this way, the instance identifier may be matched to the session identifier, and thus, to the user. The identifier is assigned to the execution instance and matched with the session identifier, so that all processes and tasks that take place as part of the operation of the execution instance can generate log entries with the identifer associated with the execution instance, and be matched to the session, and to the user. Thus, log entries are generated during the execution of the execution instance that include the identifer associated with the execution instance (STEP 525). The identifer associated with the execution instance may be communicated to, or otherwise available to, all processes, sub-processes, tasks, components, and so on, so that they can generate log entries that include the identifier associated with the execution instance.

This method is particularly beneficial when there are a number of unrelated components that are included in an execution instance, and it would otherwise be difficult to determine which log entries are associated with a user session and execution instance. Thus, debugging and auditing of a system in which many different components are used becomes possible, because the activity history may be reviewed.

Solution Engine and Action Sequences

In general, in one aspect, a solution engine architecture is used that allows a user to define and execute applications that form a business process by defining execution metadata (e.g., information used to describe the structure and content of data), managing the metadata, providing an execution environment, and defining interfaces for application integration. This creates a process-centric, solution-oriented framework with pluggable Business Intelligence (BI) components that enable companies to develop complete solutions to Business Intelligence problems.

The execution metadata, referred to as an Action Sequence, is an XML based description of processes to call and the order in which they should be called. The Action Sequence also specifies what data gets passed to which components of the system and coordinates the passing of business information between external applications. An Action Sequence is easily modifiable and makes use of an XML schema, making it easy to generate and validate with most XML editors.

The solution engine uses a solution repository, which in one embodiment, is a database that stores the Action Sequences and maintains their integrity. After editing and testing an Action Sequence, it can be published to the solution repository where it is validated against the other Action Sequences in the repository. This validation step ensures that the all Action Sequences can work together and that the contracts between documents are valid. Version control may be applied to the Action Sequences, so that modification may be controlled and audited.

The solution engine provides an execution environment, referred to as the runtime context. The runtime context performs the tasks defined by the Action Sequence Documents. It is responsible for interpreting the Action Sequence Documents, calling the components that interface with external applications and internal business logic, responding and reporting errors and reporting events to the auditing subsystem.

The interface to external applications is through the component interface. This layer translates data and requests between the runtime context and internal or external applications. It defines a pluggable architecture that allows the system to integrate with new or better technologies as they become available.

In one embodiment, the component interface allows the output of one component in an action sequence to be applied directly as input to another action. This allows components to accept, and provide, streams of binary data, which may be in the form of XML files, but also files such as ASCII files, binary files, pdf files, and the like. Passing atomic (e.g., single numbers) and textual data between components in a workflow based-based system is typically straightforward as the data can be contained in memory and passed in a portable format between agents in distributed system. For instance, it is easy for a process on one computer to call a process on another computer to create a task or convert an employee number into an employee name. It is more difficult for components in a workflow to pass large datasets that cannot be efficiently stored in memory. The component interface allows data streams to be connected directly from the output of one component to the input of another component. This enables the components (which may be external applications) to communicate directly with each other without having direct knowledge or information about the other.

For example a component that generates report content can iterate through a dataset that is a direct connection to a database component or an XML document component or an ETL (Extract/Transform/Load) component. This is achieved by creating a common set of object wrappers for binary streams and data-sets. All components that exist to integrate a data source into the system use the common data set wrappers, referred to as IPentahoConnection, IPentahoMetaData, and IPentahoResultSet. IPentahoConnection represents external datasource connections. IPentahoMetaData represents information about data in external datasets. IPentahoResultSet represents a component that integrates an external data source into the system (e.g. a database component, a web service component, or a ETL process that generates data), and creates objects that convert the external sources structures into these generic objects. For example, a component that can accept row-by-row data (e.g., a report content component) uses the functions defined by IPentahoResultSet and maps the functions to ones understood by the external application. Binary data streams are handled in a similar manner using IContentltems objects.

The action sequence can specify that the output of one component be provided as an input to another component. When the action sequence is executed, the runtimecontext initiates the components specified by the action sequence and provides the environment in which, when the components call to get their input and output objects, the components are using a single IPentahoResultSet or IContentltem.

An exemplary embodiment of computer code is included in the Appendix on compact disc, incorporated by reference into the application, including “appendix-1-source.txt.txt” and “appendix-1-source-2.txt.”

As a demonstrative example:

An action sequence specifies that a database component be used to execute a query. The action sequence specifies the query to be run and which data source connection to use. The action sequence specifies that the output of the component be a data set called ‘data-rows’. The action sequence specifies that a report component be used next. The action sequence specifies the report template to be used. The action sequence specifies that the data for the report comes from an input called ‘data-rows’.

When the RuntimeContext executes the action sequence it creates the two components and instructs the first component (database component) to execute. When the database component executes it connects to its external data source and prepares the query for execution. It does not read any data from the data source at this point. If the connection and preparation were successful, the component creates a variant of the IPentahoResultSet object that is specific to the database component and which represents the external dataset. When the database component finishes executing, and reports its success to the runtime context, no data has yet been retrieved from the external system.

The RuntimeContext provides the report component with the IPentahoResultSet. To the report component the IPentahoResultSet object is not distinguishable from other IPentahoResultSet objects. That is, the report component is not aware that this is a variant of the IPentahoResultSet that is specific to the database component. When the report component executes, it uses the IPentahoResultSet to get row-by-row data. When the report component asks for the first row of data, the IPentahoResultsSet communicates with the external data source to get the data. The dataset component is no longer part of the exchange, the IPentahoResultSet is an component-neutral interactive data set that is portable to all components.

In a similar manner, the IContentltem represents binary data streams.

Classes that Implement the Parts of the Solution Engine

The following classes, found in the computer code in the appendix, implement parts of the solution engine.

Base Solution Engine:

org.pentaho.solution.ISolutionEngine.java

org.pentaho.solution.SimpleParameterProvider.java

org.pentaho.solution.SolutionEngine.java

org.pentaho.system.SolutionContextListener.java

Processing Action Sequence Documents:

org.pentaho.solution.ActionDefinition.java

org.pentaho.solution.ActionParameterSource.java

org.pentaho.solution.ActionResource.java

org.pentaho.solution.ActionSequence.java

org.pentaho.solution.IActionDefinition.java

org.pentaho.solution.IActionResource.java

org.pentaho.solution.IActionSequence.java

org.pentaho.solution.ISequenceDefinition.java

org.pentaho.solution.IOutputDef.java

org.pentaho.solution.OutputDef.java

Solution Repository Interface:

org.pentaho.solution.ISolutionRepository.java

org.pentaho.solution.SolutionPublisher.java

org.pentaho.publisher.IBasePublisher.java

org.pentaho.solution.ISolutionPublisher.java

Execution Environment:

org.pentaho.solution.HTTPRequestParameterProvider.java

org.pentaho.solution.HTTPSessionParameterProvider.java

org.pentaho.solution.IActionCompleteListener.java

org.pentaho.solution.IOutputDef.java

org.pentaho.solution.IOutputHandler.java

org.pentaho.solution.IParameterProvider.java

org.pentaho.solution.SimpleOutputHandler.java

org.pentaho.solution.SimpleParameterProvider.java

org.pentaho.runtime.ActionParameter.java

org.pentaho.runtime.IActionParameter.java

org.pentaho.runtime.IRuntimeContext.java

org.pentaho.runtime.RuntimeContext.java

Component Interface:

org.pentaho.component.ComponentBase.java

org.pentaho.component.IComponent.java

org.pentaho.component.EmailComponent.java

org.pentaho.component.JavascriptRule.java

org.pentaho.component.PrintComponent.java

org.pentaho.component.ReciptAuditComponent.java

org.pentaho.component.SQLLookupRule.java

org.pentaho.component.UtilityComponent.java

Action Sequence XML Definition

The following is an exemplary XML definition for the Action Sequence.

```
<action-sequence> REQUIRED - Top level node for the Action Sequence Document
    <name> REQUIRED - The name of the Action Sequence. It must match the file name
    of the Action Sequence Document.
    <version> NOT USED - The version of this document
    <title> NOT REQUIRED - Friendly name of the document. Used for display only
    <logging-level> NOT REQUIRED - Sets the logging level for the entire Action
    Sequence. Valid values are: TRACE, DEBUG, INFO, WARN, ERROR and FATAL. If
    no logging level is set, ERROR will be used.
    <documentation> NOT REQUIRED - Contains descriptive nodes used for generating
    documentation.
        <author> - NOT REQUIRED - The author of this Action Sequence
        <description> - NOT REQUIRED - Short (1-3 lines) description of the Action
        Sequence. This description is used by the solution navigation component to
        generate its display.
        <help> - NOT REQUIRED - Long Description of the Action Sequence including
        instructions for it's use by an end user.
        <result-type> - NOT REQUIRED - Type of output this Action Sequence will
        generate. It is used by the solution navigation component to generate its display.
        Action Sequences without a result-type will not be displayed by the navigation
        component. Valid values are: Report, Process, Rule, View and None.
        <icon> - NOT REQUIRED - Thumbnail image that the navigation component
        will use for generating its display. The path to the image is relative to the root
        context. For example: /style/icons/Example1_image.png
    <inputs> - NOT REQUIRED - Collection of input parameters.
        <param-name type=”data-type” > - NOT REQUIRED - param-name is the
        name of a parameter that the Action Sequence is expecting to be available at run
        time. The type attribute specifies the data type of this parameter. See below for
        valid data types.
            <default-value> - NOT REQUIRED - Allows the input parameter to
            specify a default value if a value has not been supplied. If the default-
            value node is present but has no value specified, the user will be prompted
            for the value if possible.
            <sources> - NOT REQUIRED - list of parameter providers in the order
            they should be queried to obtain a parameter. Valid values are request,
            session and runtime.
            Note: if a param-name is set but default-value and sources are both not
            specified, a validation error will occur.
    <outputs> - NOT REQUIRED - Collection of output parameters.
        <param-name type=”data-type” > - NOT REQUIRED - param-name is the
        name of a parameter that the Action Sequence is expecting will be set by the time
        all action-definitions have executed. The type attribute specifies the data type of
        this parameter. See below for valid data types.
    <logging-level> NOT REQUIRED - Sets the logging level during this execution of the
    action-definition. Valid values are: TRACE, DEBUG, INFO, WARN, ERROR and
    FATAL. If no logging level is set, ERROR will be used.
    <resources> - NOT REQUIRED - Collection of resource parameters.
    <resource-name> - NOT REQUIRED - resource-name is the name of a
    resource that the Action Sequence is expecting to use. The type attribute
    specifies the data type of this parameter. See below for valid data types.
        <resource-type> - REQUIRED - The name of the type of resource
        required. Valid values are: solution-file, file and url.
            <location> - REQUIRED - The path to the resource. For a
            resource-type of “solution-file”, the location is a pathname relative
            to the top level of the current solution. If the resource-type is
            “file” then the location is assumed to be the a fully qualified path.
            For resource-type of “url” the location is assumed to be a fully
            qualified URL.
            <mime-type> - NOT REQUIRED - Gives a hint about the mime
            type of the resource.
<actions loop-on=”parameter-name”> - REQUIRED - The actions node contains
“action-definition” nodes and possibly more “actions” nodes.
```

The nodes within “actions” can be executed multiple times based on the loop-on attribute. If loop-on specifies a parameter that is of type list, then the group of nodes will be executed once for each element in the list. An input parameter will be generated with the same name as the loop-on attribute but it will have the value of one element in the list. For example: if a loop-on attribute named “department” is a string-list with department names, then a parameter named department will be available and be set to a different department name in each iteration.

```
<actions loop-on=”parameter-name”> - NOT REQUIRED - Since a single level
of looping is not very fun, actions nodes can be nested within actions nodes to any level
desired - no matter how silly it may be to do so.
<action-definition> - REQUIRED (At least 1) - It defines one complete call to a
component for execution of a task.
    <action-inputs> - NOT REQUIRED - Collection of action-input
    parameters.
        <input-name type=”data-type” mapping=”param”> - NOT
        REQUIRED - input-name is the name of a parameter that the
        Action Definition is expecting to be available at run time.
        The type attribute specifies the data type of this parameter. See
        below for valid data types.
        The mapping attribute allows this input to be mapped to an Action
        Sequence input or a previous action-definition output with a
        different name.
    <action-outputs> - NOT REQUIRED - Collection of action-output
    parameters.
        <output-name type=”data-type” > - NOT REQUIRED - output-
        name is the name of a parameter that the Component will have set
        by the time it finishes executing. The type attribute specifies the
        data type of this parameter. See below for valid data types.
    <component-name> - REQUIRED - The fully qualified java class name
    for the component to execute.
    <component-definition> - REQUIRED - The component specific XML
    definition. See the documentation for the specific component for more
    information. This node may be empty but it must exist or a validation
    error will occur.
```

Action Sequence Data Types

In one embodiment, the following data types may be supported by a BI Platform.

string—The standard old Java String.

Example: This XML node defines a string with a default value of “Central.” The RuntimeContext will first look for an input parameter named “REGION” in the http request. It will then ask the session for an object named “aRegion.” If neither have a value it will create a string set to “Central”.

```
  <region type=“string”>
  <default-value>Central</default-value>
  <sources>
    <request>REGION</request>
    <session>aRegion</session>
  </sources>
</region>
```

long—A Java Long Object.

Example: This XML node defines a long with a default value of 25.

<amount type=“long”>
<default-value>25</default-value>
</amount>

string-list—A list of Java String Objects.

Example: This XML node defines a string-list with the name “to-address” with 4 entries. Items in the list are contained within <list-item> nodes.

```
<to-address type=“string-list”>
<default-value type=“string-list”>
    <list-item>joe.pentaho@pentaho.org</list-item>
    <list-item>admin@pentaho.org</list-item>
    <list-item>sales@pentaho.org</list-item>
    <list-item>noxidj@pentaho.org</list-item>
</default-value>
</to-address >
```

property-map—A property map of Java Strings.

Example: This XML node defines a property-map with the name “veggie-data” with 4 name value pairs. Items in the list are contained within <entry key=“xxx”> nodes. Property maps are sometimes used to represent a single row of data from a database query. The keys map to column names and the value maps to that column's data.

```
    <veggie-data type=“property-map ”>
      <default-value type=“property-map”>
        <property-map>
          <entry key=“name”>carrot</entry>
          <entry key=“color”>orange</entry>
          <entry key=“shape”>cone</entry>
          <entry key=“texture”>bumpy</entry>
        </property-map>
      </default-value>
</veggie-data>
```

property-map-list—A list of property maps of Java Strings.

Example: This XML node defines a property-map with the name “fruit-data” with 3 property-map sets. Items in the list are contained within <entry key=“xxx”> nodes. Property map lists are sometimes used to store the result of a database query. Each property map in the list represents 1 row of data with the keys mapping to column names and the values mapping to data cells.

```
<fruit-data type=“property-map-list”>
  <default-value type=“property-map-list”>
    <property-map>
      <entry key=“name”>orange</entry>
      <entry key=“color”>orange</entry>
      <entry key=“shape”>sphere</entry>
      <entry key=“texture”>dimply</entry>
    </property-map>
    <property-map>
      <entry key=“name”>grapefruit</entry>
      <entry key=“color”>Yellow</entry>
      <entry key=“shape”>sphere</entry>
      <entry key=“texture”>dimply</entry>
    </property-map>
    <property-map>
      <entry key=“name”>cucumber</entry>
      <entry key=“color”>green</entry>
      <entry key=“shape”>ellipsoid</entry>
      <entry key=“texture”>smooth</entry>
    </property-map>
  </default-value>
</fruit-data>
```

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

1. A method for logging data in a business process workflow, comprising the steps of:
assigning a session identifier to a user session upon initiation by a user of the user session;
generating first audit data comprising the session identifier and a user identifier;
assigning an instance identifier to an execution instance initiated by the user during the user session;
generating second audit data comprising the session identifier and the instance identifier; and
generating log entries during the execution of the execution instance, the log entries comprising the instance identifier.

2. The method of claim 1 wherein the execution instance comprises tasks to be performed on behalf of the user.

3. The method of claim 2 wherein the execution instance comprises a reporting task.

4. The method of claim 1, further comprising the step of associating the log entries with the session and the user based on the second audit data.

5. The method of claim 4, wherein the step of associating the log entries with the session and the user further comprises associating the additional log entries with the session and the user based on the second audit data comprising the session identifier and the instance identifier, and the first audit data comprising the session identifier and the user identifier.

6. The method of claim 1 wherein the log entries are generated using a log function provided by an application server.

7. The method of claim 1 wherein the log entries are generated using a function provided by a logging tool.

8. The method of claim 1 wherein the initiation of the user session comprises authentication of the user.

9. The method of claim 1, wherein the step of generating log entries during the execution of the execution instance comprises generating a log entry when an action sequence is started.

10. The method of claim 1, wherein the step of generating log entries during the execution of the execution instance comprises generating a log entry when an action sequence is completed.

11. The method of claim 1, wherein the first audit data and the second audit data are stored in a database.

12. The method of claim 1, wherein the first audit data is stored in a log entry.

13. The method of claim 1, wherein the second audit data is stored in a log entry.

14. A system for logging data in a business process workflow, comprising:
an audit data store for storing identifiers of execution instances, session identifiers, and user identifiers; and
a log file that includes for each log file entry generated by an execution instance an identifier of the execution instance that generated the entry.

15. The system of claim 14, wherein the log file further comprises a first log entry generated at the initiation of a session comprising a session identifier and a user identifier.

16. The system of claim 15, further comprising a second log file entry generated at the initiation of an execution instance comprising the session identifier and the instance identifier.

17. The system of claim 14, wherein the log file further includes for each log file entry generated by an execution instance one of the following: identifier for each process, identifier of the parent of the instance, identifier of an activity, identifier of a component executing the activity, date and time of each event, and relevant attributes.

18. The system of claim 14, wherein the log file further includes for each log file entry generated by an execution instance two or more of the following: identifier for each process, identifier of each executing instance, identifier of the parent of the instance, identifier of an activity, identifier of a component executing the activity, date and time of each event, and relevant attributes.

19. The system of claim 14, wherein the log file comprises an entry generated when an action sequence is started.

20. The system of claim 19, wherein the log file comprises an entry generated during action execution.

21. The system of claim 20, wherein the log file comprises an entry generated during action sequence completion.

22. The system of claim 14, wherein the log file comprises a relational database table.

23. A method for executing applications that form a business process, comprising:
defining an action sequence comprising a description of business intelligence processes to call and the order in which they should be called;
storing the action sequence in a solution repository;
executing the action sequence such that the business intelligence processes defined in the stored action sequence are called in the order specified, thereby implementing a business process.

24. The method of claim 23, wherein the action sequence comprises a description of components to call and the order in which they should be called.

25. The method of claim 24, wherein the action sequence is implemented in XML.

26. The method of claim 23, wherein the solution repository is a database for storing action sequences.

27. The method of claim 23, wherein the business intelligence processes are business intelligence platform components.

28. The method of claim 27, wherein the output of one component in the action sequence is provided as input to a next component in the action sequence.

29. The method of claim 27, wherein the execution is performed by a runtime engine.

30. The method of claim 23, further comprising:
developing the action sequence; and
testing the action sequence.

31. The method of claim 23, further comprising the step of validating the action sequence.

32. The method of claim 23, wherein the step of storing the action sequence in a solution repository is performed by a solution engine.

33. A business intelligence platform for executing applications that form a business process, comprising:
a development environment for defining an action sequence comprising a description of business intelligence processes to call and the order in which they should be called;
a solution engine for storing the action sequence in a solution repository;
a runtime engine for executing the action sequence such that the business intelligence processes defined in the stored action sequence are called in the order specified, thereby implementing a business process.

34. The system of claim 33, wherein the action sequence comprises a description of components to call and the order in which they should be called.

35. The system of claim 34, wherein the action sequence is implemented in XML.

36. The system of claim 33, wherein the solution repository is a database for storing action sequences.

37. The system of claim 33, wherein the business intelligence processes are business intelligence platform components.

38. The system of claim 33, wherein the output of one component in the action sequence is provided as input to a next component in the action sequence.

39. The system of claim 33, wherein the execution is performed by a runtime engine.

40. The system of claim 33, further comprising:
a development environment for developing the action sequence and
an execution environment for testing the action sequence.

41. The system of claim 33, further comprising the step of validating the action sequence.
